(19) United States
(12) Patent Application Publication
(10) Pub. No.: US 2005/0172267 A1
(43) Pub. Date: Aug. 4, 2005

(54) Method and system for testing software

(76) Inventor: Derek Bergin, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/767,771

(22) Filed: Jan. 30, 2004

(51) Int. Cl. G06F 9/44

(52) U.S. Cl. 717/124

(57) ABSTRACT

A method and system for testing software that includes receiving a plurality of test-modules associated with an external system and organized into a sequence, each test-module including at least a software-targeted testing-inquiry that generates a plurality of intermediate results, the test module returning a distilled result based upon the results, receiving one or more rules to which at least one of the test-modules in the sequence is subject, application of each rule having one or more outcomes, at least one outcome for each rule being the determination of the next test-module to be administered, each rule including one or more actions conditioned upon the distilled result returned by the corresponding test module, the one or more conditioned actions being configurable to be a branch out of the sequence to a predetermined test-module; administering the sequence of test-modules sequentially except where a branch is invoked to administer the sequence from another point in the sequence, the administering of a current test-module including executing the current test-module, the executing including sending signal bits to the external system, and applying, if the current test-module is subject to one or more rules, such one or more rules.

### BACKGROUND OF THE INVENTION

Testing software is often used to improve the quality of a software program (subject software). In a software based testing environment, software defects and errors may be identified and isolated by the use of testing software to test the subject software.

Diagnostic testing software, for example, is a form of testing software. Diagnostic testing software may be used to identify subject software failures and provide an engineer with information to help isolate and repair problems. The diagnostic testing software may be used to detect a problem in subject software that causes a failure during software development. Using diagnostic testing software, defects may be found that would allow the engineer to repair subject software at a module level. Diagnostic testing software helps the engineer to isolate a problem and to determine what caused the failure so that the system may be repaired.

Diagnostic testing software may include a set of sub-tests that are run in a predetermined sequence. In diagnostic testing, the sub-tests may be initially run to test small portions of a system. The test coverage of the diagnostic testing software is then gradually increased until the entire system is tested. The test sequence helps isolate errors at lower levels of subject software so that the cause of the errors may be understood. However, engineer intervention is often required to help the diagnostic test progress.

Verification testing software is another form of testing software. Verification testing software is used to determine if subject software is either defective or good. Verification software detects defects so that if subject software passes a defects test, the system should be good. If defects are found, then diagnostic software can be used to identify the causes. An example of a verification software test is a test until failure test. Repetitively subjecting subject software to testing using the same test helps engineers determine whether the subject software will withstand the different demands a user may put on the software.

A typical test environment includes a platform to be tested and an engineer who conducts the testing. The engineer designs a test plan, i.e., a set of tests, which takes into account the different aspects of a system to be tested and tests the system according to the tests generated. Tests are planned and supervised by the engineer, but when a problem arises using conventional testing methods as described above, conventional testing software merely reports that a problem has occurred and typically stops a test in progress to alert the engineer.

### SUMMARY OF THE INVENTION

At least one embodiment of the invention is directed to a method for testing software. Such a method may include: receiving a plurality of test-modules associated with an external system and organized into a sequence, each test-module including a software testing-inquiry that generates a plurality of intermediate results, the test module returning a distilled result based upon the results, receiving one or more rules to which at least one of the test-modules in the sequence is subject, application of each rule having one or more outcomes, at least one outcome for each rule being the determination of the next test-module to be administered, each rule including one or more actions conditioned upon the distilled result returned by the corresponding test module, the one or more conditioned actions being configurable to be a branch out of the sequence to a predetermined test-module; administering the sequence of test-modules sequentially except where a branch is invoked to administer the sequence from another point in the sequence, the administering of a current test-module including executing the current test-module, the executing including sending signal bits to the external system, and applying, if the current test-module is subject to one or more rules, such one or more rules.

### BRIEF DESCRIPTION OF THE DRAWINGS

FIG. 1A is an example of a block diagram of an automated testing system according to an embodiment of the invention;

FIG. 1B is an example logical structure of a template according to an embodiment of the invention;

FIG. 2 is an example of a flow diagram of creating a test sequence according to an embodiment of the invention;

FIG. 3 is an example of a flow diagram of test sequence processing according to an embodiment of the invention;

FIG. 4 is an example of a flow diagram of processing an action according to an embodiment of the invention; and

FIG. 5 is an example of a screen shot of a graphical user interface for creating a test sequence according to an embodiment of the invention.

Additional features and advantages of the invention will be more fully apparent from the following detailed description of example embodiments, the appended claims and the accompanying drawings.

### DETAILED DESCRIPTION OF EMBODIMENTS

An embodiment of the invention, at least in part, is the recognition of the following. Systems for testing software, according to the background art, run in lock-step to a test sequence, independent of test results. They are essentially dumb systems for testing software. A batch of software tests are run against subject software and data is collected. The sequence of execution is not a function of test results. Thus, a problem with such testing is that an engineer must comb through test results that may be too numerous to determine a problem with the subject software and what test to perform next based on the test results. Depending on the volume of test results, the task of analyzing test results and setting up new tests could be daunting. Moreover, testing with extensive engineering interaction can be very costly and inefficient using such testing technology.

An embodiment of the invention permits an engineer or a user in need of test results to run numerous test-modules without user intervention or at least a significantly lessened amount of user intervention.

Automated Testing System 100

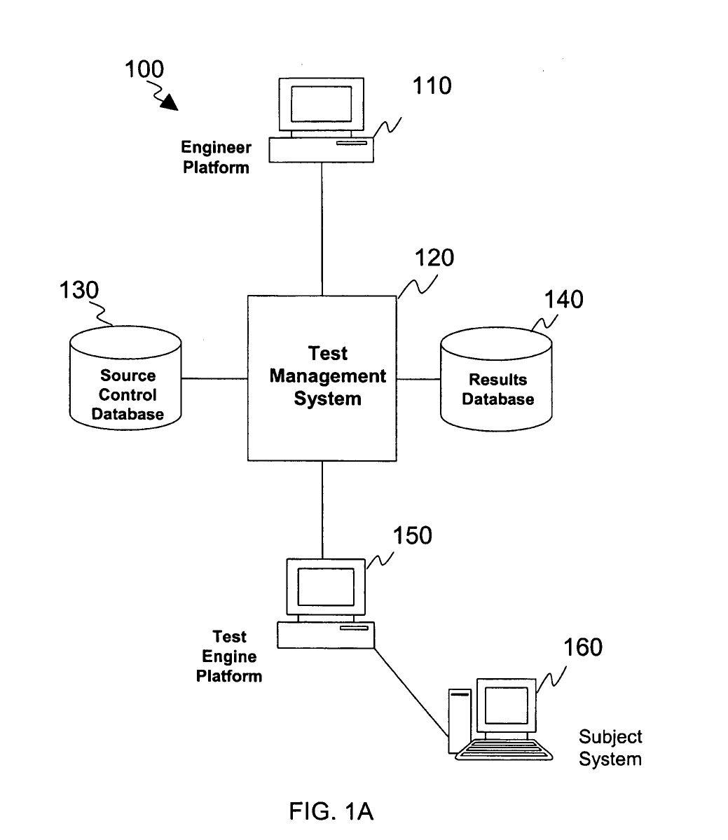

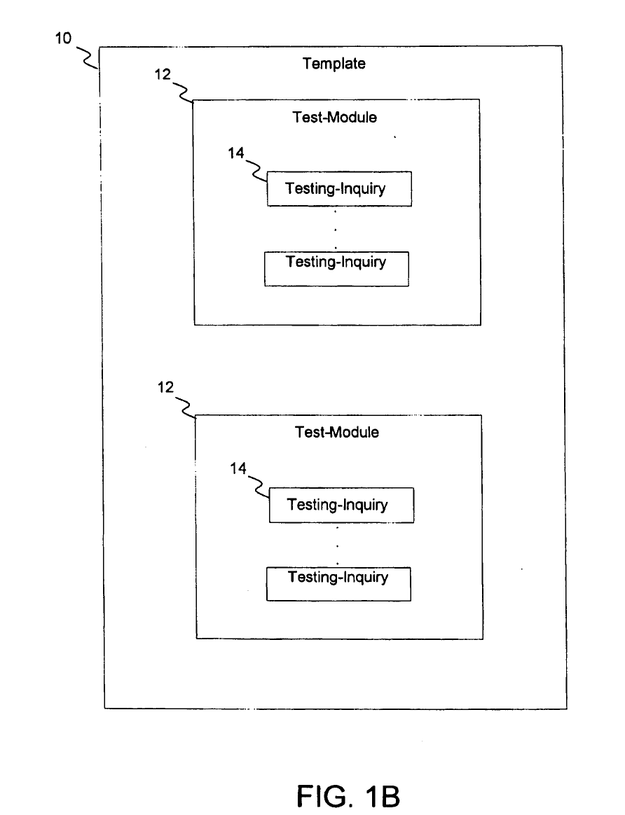

FIG. 1A is an example of a block diagram of an automated testing system 100 according to an embodiment of the invention. The automated testing system 100 may be used to run numerous test-modules against a subject system 160 without user intervention or at least a significantly lessened amount of user intervention. The automated testing system 100 includes: an engineer platform 110; a test management system 120; source code control database 130; results database 140; test engine platform 150; and the subject system 160. The subject system 160 is shown as part of the automated testing system 100, but may be a system separate from the automated testing system 100.

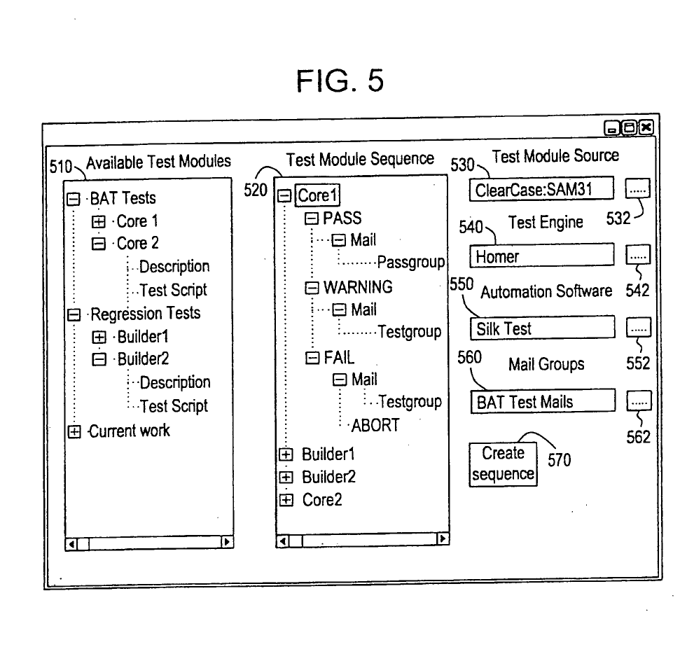

The engineer platform 110 may be a personal computer (PC) or other terminating system by which an engineer, or other user associated with running test-modules against the subject system 160, can retrieve test-modules from the source control database 130, arrange the test-modules into a test-sequence, and receive associated test results. More detail of the user interface is later described in the discussion of FIG. 5. The engineer platform 110 may be connected directly or indirectly to the test management system 120.

The engineer platform 110 receives from the test management system 120 a list of available test-modules that may be applied to the subject system 160 and presents them to the user via a graphical user interface. The engineer platform 110 further provides the user with the results of test-modules and their related software-targeted testing-inquires of the subject system 160. The engineer platform 110, additionally, receives test-module sequence information associated with the subject system 160 from the user and sends it to the test management system 120.

The test management system 120 may be a PC, a plurality of computers, or other computing device that can host software to provide input/output capabilities. Such input/output capabilities can include web server capability, Email server capability (or other communications capability such as paging, calling, and the like), and provide access to a source control database 130 and results database 140. The test management system 120 may be connected directly or indirectly to the engineer platform 110, the source control database 130, the results database 140, and the test engine platform 150. The test management system 120 provides a majority of the processing for the automated testing system 100.

The test management system 120 receives from the source control database 130 available test-modules associated with the subject system 160 and sends a list of available test-modules to the engineer platform 110. The test management system 120 may further receive test-module sequence information from the engineer platform 110, process it, and send testing information to the test engine platform 150. The test management system 120 also may receive test-module results or software-targeted testing-inquiry results from the test engine platform 150, process the results, store the results in the results database 140 and send test-module results or software-targeted testing-inquiry results to the engineer platform 110 by Email or by other media such as a pager system, telephone system, and the like.

The source control database 130 may be any database such as a Oracle, IBM DB2, or Lotus Notes database residing on a PC, workstation, server system, or the like. The source control database may be connected to the test management system 120. Further, the source control database 130, may be accessed locally or remotely for receiving templates including test-modules from engineers.

The source control database 130 is originally populated by engineers using templates that include test-modules. The test-modules include mappings of possible software-targeted testing-inquiry results of the subject system 160 to states such as PASS, FAIL, or WARNING. The source control database 130 stores and provides the test-modules that are available to the test management system 120.

The results database 140 may be any database such as an Oracle, IBM DB2, or Lotus Notes database residing on a PC, workstation, server system, or the like. The results database 140 may be connected to the test management system 120.

The results database 130 stores log files and results from the test-modules applied to the subject system 160. The results database 130 receives test-module result information from the test management system 120.

The test engine platform 150 may be a PC or like system that performs testing-inquiries on the subject system 160 and provides an interface to the subject system 160. The test engine platform 150 may be connected directly or indirectly to the test management system 120.

The test engine platform 150 receives testing information from the test management system 120 and administers test-modules on the subject system 160. At least one of the test-module results or software-targeted testing-inquiry results are received from the subject system 160 are processed and sent to the test management system 120 from the test engine platform 150. In so doing, the test engine platform 150 administers a sequence of test-modules sequentially except where a branch is invoked to administer the sequence from another point in the sequence. The administering of a current test-module includes executing the current test-module and applying, if the current test-module is subject to one or more rules, such one or more rules.

The subject system 160 may be a system including subject software, hardware system, or any type of system that needs testing. For example, the subject system 160 may include subject software. The subject system 160 receives testing-inquiries from the test engine platform 150 in the form of signal bits, executes the software-targeted testing-inquiry, and sends the software-targeted testing-inquiry results to the test management system 120 and test engine platform 150.

While the engineer platform 110, source control database 130, test management system 120, results database 140, and test engine platform 150 are shown as being separate elements, they may be combined in various configurations to be part of one or more platform. Moreover, the databases 130, 140 may be part of one database on one machine.

Template Creation

Prior to using the automated testing system 100, engineers plan and create templates that include at least one test module as shown in FIG. 1B. FIG. 1B shows an example logical structure of a template according to an embodiment of the invention. Template 10 may include one or more test-modules 12. The template 10 is generated by a test-engineer and is stored in the source control database 130.

The test-module 12 includes multiple software-targeted testing-inquiries 14. The test-module 12 may be created using Silk™, PERL, a combination thereof, or any other tool that may be used to aid in the processing of results from the software-targeted testing-inquiries 14. When a test-module 12 is administered by the automated testing system 100, the returned value is a distilled result which is later described.

The software-targeted testing-inquiries 14 are individual tests used by the test engine platform 150 to query the subject system 160. Each software-targeted testing-inquiry 14 may be part of or one of an integration test, functional test, system test, combination thereof, and any other like tests as are known in the art used to test software. The test engine platform 150 executes the software-targeted testing-inquiry 14 which causes signal bits to be sent to subject software running on the subject system 160. The signal bits can be used to determine whether the subject system 160 satisfies any of the conditions associated with a particular software-targeted testing-inquiry 14.

In creating a test-module 12 for use in an embodiment of the invention, an engineer also maps the possible software-targeted testing-inquiry 14 results of the test-module to a cumulative value known as a distilled result. The distilled result reflects the cumulative results of the software-targeted testing-inquiries 14 when the test-module 12 is administered and is also the output of the test-module 12.

Associating Test-Modules with Rule Sets

After templates are created and loaded into the source control database 130, they are then available for manipulation and sequencing by a user. A user (e.g., engineer) may create a test-module sequence from a list of available test-modules 12 included in one or more templates. Using a graphical user interface, later discussed in the explanation of FIG. 5, the user may select test-modules 12 from a list of available test-modules 12 in the database, place the test-modules 12 into a sequence for execution, and associate a rule set for each test-module 12 selected.

Rule sets are conditional constructs associated by a user to a test-module's 12 possible distilled results and include at least one or more rule. Each rule includes a condition associated with one of the test-module's 12 distilled results, and one or more actions. The conditions of the rule set may be provided to the user when a test module is selected. Alternatively, the user may already know which possible distilled results have been associated by an engineer when creating the test-module 12. In this case, the user may create conditions that address each of the distilled results for a particular test-module 12. The condition is used in determining what action to take based on a particular distilled result from an administered test-module 12. The distilled result in this context acts as a trigger to invoke the action.

An example rule set for an example test-module A may take the following logical form:
Rule 1: If test module A's distilled result is PASS, then continue to the next test module.
Rule 2: If test module A's distilled result is FAIL, then Email tester1.
Rule 3: test module A's distilled result is WARNING, then Email tester2.

In the above example, Rules 1, 2, and 3 make up the rule set. With regard to Rule 1, the condition is: test module A's distilled result is a PASS. Here, the distilled result that acts a trigger for Rule 1 is the distilled result of PASS. The action of Rule 1 is to continue to the next test-module.

The action may be a command to send a communication, abort an operation, skip the next test-module in sequence, repeat the current test-module, execute a particular test-module, execute a shell script, etc. Moreover, the conditions and associated actions may be nested. For example a rule may logically take a form that if a test-module passes, another test-module is administered. This is so since one or more actions associated with a condition may be configurable to be a branch out of a sequence to a predetermined test-module.

Accordingly, when the test-module 12 is administered and a distilled result of the test-module 12 is PASS, the condition of Rule 1 is satisfied. The distilled result of PASS triggers the automated testing system 100 to continue to the next test-module 12 as per Rule 1. Similar activity occurs if the distilled result of the test-module is a FAIL or WARNING according to Rules 2 and 3, respectively.

In addition to the above example, rule sets may include actions that adaptively adjust the test-module 12 sequence. For example, a rule may include an action to repeat a test-module 12 until distilled results representing a PASS state are returned from the test-module 12. The ability to alter the sequence is a valuable tool that additionally helps enable testers to automate much of their activities and perform complex test executions and test groupings that are otherwise too costly or complex for human implementation.

To restate, test-modules 12 include software-targeted testing-inquiries 14 that, when invoked, act on the subject system 160. A rule set is associated with a test-module 12. A rule in a rule set may include at least one condition and one action associated with the test-module's 12 distilled result. A test-module is implemented using at least one software-targeted testing-inquiry 14, while a rule associates a test-module's 12 distilled result with a condition and an action. An engineer designs the software-targeted testing-inquiries 14 and incorporates them into test-modules 12 for submission into the source control database 130 via a template. A user, subsequently, selects test-modules 12 from the source control database 130, places them into an execution sequence and associates a rule set to the test-modules 12 using the engineer platform 110.

While the above example describes a rule associated with a test-module 12, not every test-module 12 needs to be associated with a rule when placed by the user into a test sequence.

To adjust to different environments, the engineers may create test-modules suitable for the particular environment and the test engine platform 150 may be configured to provide an interface to the subject system. Embodiments of the invention are described in terms of use in an environment for testing software. However, the invention may also be used in a hardware testing environment where hardware is the subject of testing.

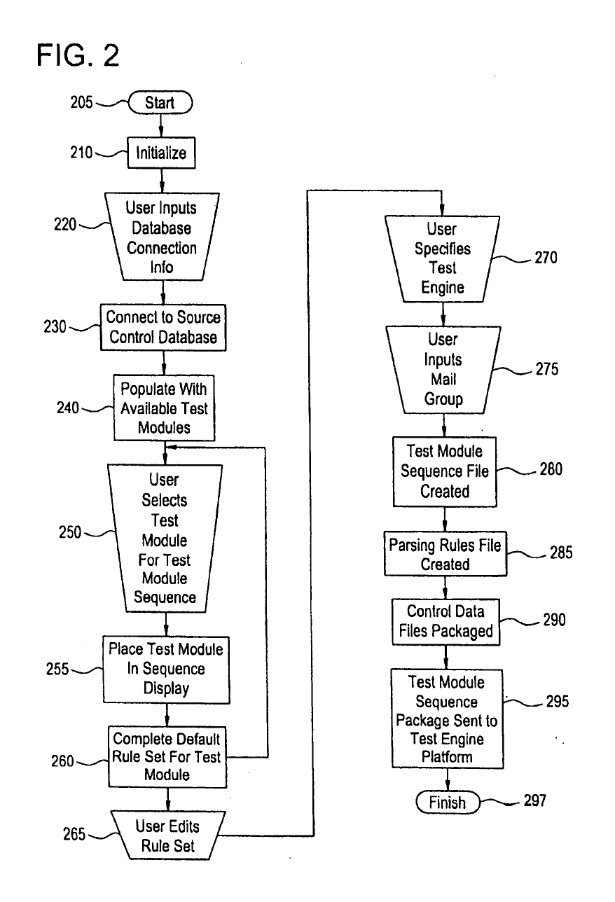

FIG. 2 is an example of a flow diagram of creating a test-module sequence according to another embodiment of the invention. The creation of a test-module sequence is an interaction between the automated testing system 100 and the user. The user may use the engineer platform 110 to interact with the automated testing system. The create test-module sequence process is initialized at block 210. Initialization may include logging in a user to an account. The user may then input database connection information at block 220, and later specify a test engine at block 270, or input an Email address at block 275.

At block 220, the user may input database connection information into the engineer platform 110. This may include the designation of a database and database-secure logon information. The user is then connected to the source control database 130 via the engineer platform 110 and test management system 120 at block 230. The interaction of the user may include presenting to the user a graphical user interface, e.g., corresponding to the screen-shot of FIG. 5, to facilitate creating a test-module sequence. Available representations of test-modules 12 may then be retrieved from the source control database 130 and be used to populate an engineer platform 110 screen, block 240, from which the user may select the available test-modules 12 to be used when testing the subject system 160. As previously described, the test-modules 12 are made available by an engineer that has previously entered them into the source control database 130 via a template 10 that includes the test-modules 12. After the screen has been populated with a list of available test-modules 12, the user may then select the test-modules 12 to create a test-module sequence, block 250, to be used in testing the subject system 160. The create sequence process then continues by placing the selected available test-modules information into a test sequence display, block 255, on the user's screen.

A default rule set may be added to the test sequence display at block 260. Examples of default rules may include: 1) if the result of a test-module is a PASS, then send an Email to a mailing list; 2) if the result of a test-module is a WARNING, send an Email to those on a second mailing list; and 3) if the result of a test-module is a FAIL, then send an Email to those on a third mailing list. After the test-module sequence display is populated, the user may then edit the test-module sequence and rule sets therein at block 265.

At block 270, the user may specify a particular test engine platform 150 to be used for testing the subject system 160. Additionally, the user may input a mail group, block 275, designating which Email group or lists recipients may be pulled from. A mail group may be a list of Email addresses or address lists. While in this example Email addresses are used, pager addresses, telephone numbers, or the like may also be used.

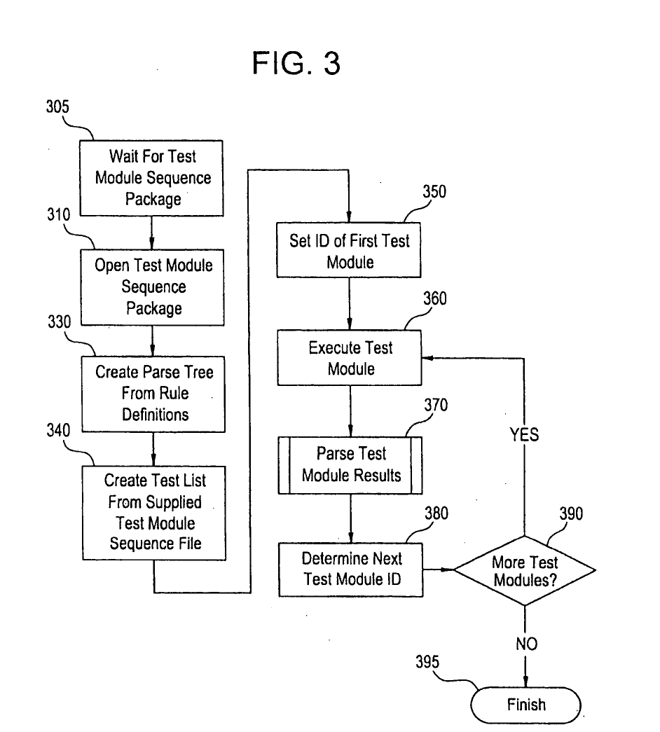

At block 280, a test-module sequence file is created by the test management system 120, including the test engine information and mail group information. Also included in the test-module sequence file may be a user designation of where a test may be found and the automation software to be used by the test-module. The test management system 120 may then create a parsing rule file for parsing rule sets at block 285. Control data files containing control information are then packaged by the test management system 120 at block 290. Further, at block 295, testing information in the form of a test-module sequence package including the package of control data files and the test-module sequence file are sent to the test engine platform 150 at block 295 where it is processed. After a test definitions file is sent in block 295, the create test-module sequence process is then finished at block 297. The processing of the test definition package is shown in FIG. 3.

FIG. 3 is an example of a flow diagram of test-module sequence processing according to another embodiment of the invention.

The test-module sequence process is executed by the test engine platform 150. It details the processing of a sequence by the test engine platform 150. At block 305, the test engine platform 150 waits for a test-module sequence package from the test management system 120. Once received, the test-module sequence package is opened at block 310. A parsing tree is then created at block 330 from the parsing rule file created at block 285 for use in processing test results from the subject system 160. After the parsing tree is created, a test-list is created at action 340 from the test sequence file of block 280 and each test-module is assigned an ID. The test-module list includes a list of test-modules with IDs to be run on the subject system 160.

At block 350, a first test is selected from the test-list on the basis of test-module ID to be executed. The test-module is then executed on the subject system 160 at block 360. The test engine platform 150 passes testing-inquiries to the subject system 160 as part of the test-module execution process. During execution of the test-module, software-targeted testing-inquiry results are received by the test engine platform 150 from the subject system 160.

The software-targeted testing-inquiry results are parsed at block 370 using the parse tree created in block 330. During the parsing process, processed software-targeted testing-inquiry results and test-module results are sent to the test management system 120 which further processes them and stores them in the results database 140 where a log of the software-targeted testing-inquiry results and test-module results is kept. As part of the parsing process the following can occur: nested software-targeted testing-inquiries are processed and identified, a hierarchy of errors may be determined among the software-targeted testing-inquiries, software-targeted testing-inquiry results are examined to see if a condition has been triggered, and/or result log files may be created. Where a result log file is created, it may also be time stamped.

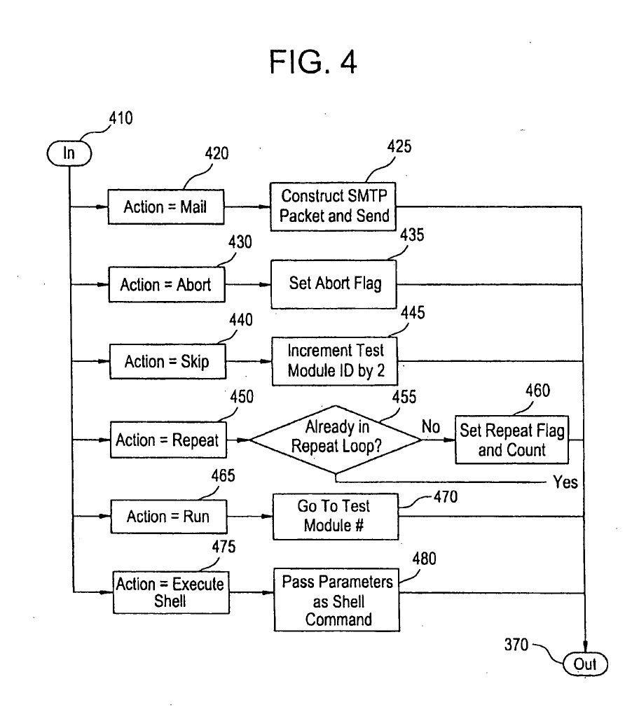

If a condition is triggered, the parser notes this and executes the action associated with the condition. An action may be to construct a mail message, set an abort flag, skip the next test-module ID, repeat the test-module, go to a specific test-module ID, or run a shell script. Examples of actions associated with conditions is further described relative to FIG. 4. After the test-module results have been parsed, the next test-module ID is determined at block 380. The selection is mainly determined by the action taken at block 370. For example, if the just-processed test-module ID is 100, and a skip action is to be executed as determined by parsing, the next test-module ID processed will be 102 (assuming an increment by one). Likewise, if a repeat action is to be executed, the next test-module ID processed remains 100. If no branching action is determined by the parsing, then the next test-module ID would be executed. By the current example, the next test-module ID processed would be 101. After the next test-module ID is determined at block 380, the test-module sequence process continues by checking if any more test-modules are to be run at block 390. If not, the test-module sequence ends at block 390. If more test-modules are to be run, the process returns to block 360 for the further processing of test-modules in the test-module sequence.

FIG. 4 is an example of a flow diagram of processing an action according to another embodiment of the invention. As mentioned previously, the parsing at block 370 determines whether a branching action is to be executed based on test-module results of software-targeted testing-inquiries run on the subject system 160 and executes the branching action.

Assuming that branching is determined in block 370, then flow proceeds to FIG. 4 starting at the input block 410, where execution of an action begins. If the action is to send Mail as determined in block 420, an SMTP packet may be constructed and sent, at block 425, by the test management system 120. If the action is to Abort as determined at block 430, an abort flag may be set at block 435. The abort flag may be used to abort the entire testing process.

If the action is to SKIP as determined at block 440, the test-module ID may be incremented by two (again, assuming the example of a default increment of one) in order to skip the next test-module ID. If the action is to REPEAT as determined at block 450, it may be determined by checking a flag and counter whether an improper loop is repeating at block 455. If improper looping is occurring, the process continues to block 370. If looping is not occurring, the repeat flag and counter may be set at block 460.

If the action is to RUN, as determined at block 465, the test-module ID may be set at block 470 to a test-module ID as determined by parsing. If the test-module ID cannot be found, a default of the next test-module ID in sequence may be selected. If the action is to EXECUTE SHELL, then a shell script or program may be run. This could be any program or command such as to reboot a system, mount new media, etc. After blocks 425, 435, 445, 460, 470, and 480, the parsing process of block 370 continues.

FIG. 5 is an example of a screen shot of a graphical user interface for creating a test-module sequence according to another embodiment of the invention. The screen shot includes an available test modules window 510, a test module sequence window 520, a test module source window 530, a Test Engine window 540, an Automation Software window 550, a Mail Groups window 560, and a Create Sequence button 570.

In the available test modules window 510, a list of available test-modules is displayed from which a user may select for testing the subject system 160. For example, the list in the available test modules window 510 shows that the BAT Tests (batch tests) named Core 1 and Core 2 may be selected. The Core 2 test-module entry, in this example, includes a description field to describe the test-module and any associated script information. The listing for the Regression Tests and Current Work tests are similarly displayed. The Current Work entry may be used to show available test-modules not readily categorized. The test-modules that may be presented is determined by the engineers that design the templates that include the test-modules stored in the source control database 130.

The test module sequence window 520 includes the test-modules selected by the user from the available test modules window 510 and user edits. Once the user has selected information from the available test modules window 510 as described in block 250 and places them into the test module sequence window 520, the user may create and edit rules in the test module sequence window 520. The example rules represented in the test module sequence window 520 for test-module Core 1 may be interpreted as: if a test-module is PASSED, send mail to the Passgroup; if a test-module returns a WARNING, send mail to the Testgroup; and if the test-module returns a FAIL, send mail to the Testgroup and abort. Similar conditions may be entered by the user in the test module sequence window 520.

The entry of information into the test module sequence window 520 may be by a drag and drop method. For example, a user may simply drag a test-module entry from the available test modules window 510 into the test module sequence window 520. Default states, potential distilled results, such as PASS, WARNING, and FAIL may appear under the selected test-module entry and default actions such as “Mail” may also be automatically provided once a test-module entry is entered into the test module sequence window 520. Additionally, rules may be edited or entered by using drop down menus or by using text entry windows.

The test module source window 530 may designate the source of test-modules to be used in populating the available test modules window 510. The test-module source entry may also be a location such as a directory name, URL, or other type of address.

The test engine window 540 may designate which test engine platform 150 to use. Entries may be in the form of a name or another type of address.

The automation software window 550 may designate which automation software to use. Entries may be in the form of a name.

The mail groups window 560 may designate the group of Email addresses to use from which a user may select mailing lists from.

The create sequence button 570 may be used to enter or save the test-module sequence.

The buttons 532, 542, 552 and 562 can be explore or browse buttons to facilitate making a selection in the windows 530, 540, 550 and 560, respectively.

Although the example embodiments described above in connection with the invention are particularly useful in software and hardware testing systems, they may also be utilized other testing environments, as would be known to one of ordinary skill in the art.

It is noted that the functional blocks in the example embodiments of FIGS. 2-4 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s) either with or without carrier wave(s).

This specification describes various illustrative embodiments of the method and system of the invention. The scope of the claims are intended to cover various modifications and equivalent arrangements of the illustrative embodiments disclosed in this specification. Therefore, the following claims should be accorded the reasonably broadest interpretations to cover modifications, equivalent structures in features which are consistent with the spirit and the scope of the invention

1. A method for testing software, the method comprising:
receiving a plurality of test-modules associated with an external system and organized into a sequence,
each test-module including at least one software-targeted testing-inquiry that generates a plurality of intermediate results, the test module returning a distilled result based upon the intermediate results,
receiving one or more rules to which at least one of the test-modules in the sequence is subject, application of each rule having one or more outcomes, at least one outcome for each rule being the determination of the next test-module to be administered, each rule including one or more actions conditioned upon the distilled result returned by the corresponding test module, the one or more conditioned actions being configurable to be a branch out of the sequence to a predetermined test-module;
administering the sequence of test-modules sequentially except where a branch is invoked to administer the sequence from another point in the sequence, the administering of a current test-module including
executing the current test-module, the executing including sending signal bits to the external system; and
applying, if the current test-module is subject to one or more rules, such one or more rules.

2. The method for testing of claim 1, further comprising:
receiving commands to arrange a portion of the plurality of test-modules to create the sequence of test-modules, and
receiving commands to associate at least one condition and at least one action to at least one test-module of the sequence of test-modules.

3. The method of claim 1 wherein, the action is at least one of sending a communication, aborting, skipping a test-module in the test-module sequence, repeating a test-module, branching, and executing a program.

4. The method of claim 3 wherein, the sending may be executed using at least one of mailing, Emailing, paging, and phoning.

5. The method of claim 1 wherein, at least one of the test-modules is repeatedly administered until passing state information is returned.

6. The method of claim 2 further comprising:
associating a test-module identification value for each test-module in the sequence, the test-module identification value corresponding to an order of the test-module sequence.

7. The method of claim 1 wherein the distilled results are determined based on a synthesis of values of the plurality of intermediate software-targeted testing-inquiry results.

8. A system that tests software, the system comprising:
means for receiving a plurality of test-modules associated with an external system and organized into a sequence,
each test-module including at least a software-targeted testing-inquiry that generates a plurality of intermediate results, the test module returning a distilled result based upon the results,
means for receiving one or more rules to which at least one of the test-modules in the sequence is subject, application of each rule having one or more outcomes, at least one outcome for each rule being the determination of the next test-module to be administered, each rule including one or more actions conditioned upon the distilled result returned by the corresponding test module, the one or more conditioned actions being configurable to be a branch out of the sequence to a predetermined test-module;
means for administering the sequence of test-modules sequentially except where a branch is invoked to administer the sequence from another point in the sequence, the administering of a current test-module including
executing the current test-module, the executing including sending signal bits to the external system; and
applying, if the current test-module is subject to one or more rules, such one or more rules.

9. The system of claim 8, further comprising:
means for receiving commands to arrange a portion of the plurality of test-modules to create the sequence of test-modules, and
means for receiving commands to associate at least one condition and at least one action to at least one test-module of the sequence of test-modules.

10. The system of claim 8 wherein, the action is at least one of sending a communication, aborting, branching, repeating a test, executing a branch, and executing a program.

11. The system of claim 10 wherein, the sending may be at least one of mailing, Emailing, paging, and phoning.

12. The system of claim 8 wherein, at least one of the test-modules is repeatedly administered until passing state information is returned.

13. The system of claim 10 further comprising:
means for associating a test identification value for each of the test-modules of the sequence, the test identification value corresponding to the order of the test sequence.

14. The system of claim 8 wherein the distilled results are determined based on a synthesis of values of the plurality of intermediate software-targeted testing-inquiry results.

15. A system that tests software comprising:
a results database,
a test engine configured to receive a plurality of test-modules associated with an external system and organized into a sequence,
each test-module including a software-targeted testing-inquiry that generates a plurality of intermediate results, the test module returning a distilled result based upon the results,
the test engine further receiving one or more rules to which at least one of the test-modules in the sequence is subject, application of each rule having one or more outcomes, at least one outcome for each rule being the determination of the next test-module to be administered, each rule including one or more actions conditioned upon the distilled result returned by the corresponding test module, the one or more conditioned actions being configurable to be a branch out of the sequence to a predetermined test-module;
the test engine further administering the sequence of test-modules sequentially except where a branch is invoked to administer the sequence from another point in the sequence, the administering of a current test-module including
executing the current test-module, the executing including sending signal bits to the external system; and
applying, if the current test-module is subject to one or more rules, such one or more rules.

16. The system of claim 15, further comprising:
a test management system configured to receive a plurality of test-modules, receive commands to arrange a portion of the plurality of test-modules to create the sequence of test-modules, and receive commands to associate at least one condition and at least one action to at least one test-module of the sequence of test-modules.

17. The system of claim 15 wherein, the action is at least one of sending a communication, aborting, skipping a test-module in the test-module sequence, repeating a test-module, executing a branch, and executing a program.

18 The system of claim 16 wherein, the test management system sends at least one of an Email, page, and phone message.

19. The system of claim 15 wherein, at least one of the test-modules is repeatedly administered until passing state information is returned.

20. The system of claim 16 further comprising:
an associating system that associates a test-module identification value for each of the plurality of test-modules, the test-module identification value corresponding to the order of the test-module sequence.

21. The system of claim 15 wherein the distilled results are determined based on a synthesis of values of the plurality of intermediate software-targeted testing-inquiry results.

22. A machine readable medium including instructions executed by a computer, the instructions comprising:
receiving a plurality of test-modules associated with an external system and organized into a sequence,
each test-module including at least a software-targeted testing-inquiry that generates a plurality of intermediate results, the test module returning a distilled result based upon the intermediate results,
receiving one or more rules to which at least one of the test-modules in the sequence is subject, application of each rule having one or more outcomes, at least one outcome for each rule being the determination of the next test-module to be administered, each rule including one or more actions conditioned upon the distilled result returned by the corresponding test module, the one or more conditioned actions being configurable to be a branch out of the sequence to a predetermined test-module;
administering the sequence of test-modules sequentially except where a branch is invoked to administer the sequence from another point in the sequence, the administering of a current test-module including
executing the current test-module, the executing including sending signal bits to the external system; and
applying, if the current test-module is subject to one or more rules, such one or more rules.

23. The machine readable medium of claim 22, further including instructions executed by a computer, the instructions comprising:
receiving commands to arrange a portion of the plurality of test-modules to create the sequence of test-modules, and
receiving commands to associate at least one condition and at least one action to at least one test-module of the sequence of test-modules.

24. The machine readable medium of claim 22 wherein, the action is at least one of sending a communication, aborting, skipping a test-module in the test-module sequence, repeating a test-module, executing a test-module out of sequence, and executing a program.

25. The machine readable medium of claim 24 wherein, the sending may be executed using at least one of mailing, Emailing, paging, and phoning.

26. The machine readable medium of claim 22 wherein, at least one of the test-modules is repeatedly administered until passing state information is returned.

27. The machine readable medium of claim 23 further comprising associating a test-module identification value for each test-module of the sequence of test-module, the test-module identification value corresponding to the order of the test-module sequence.

28. The machine readable medium of claim 22 wherein the distilled results are determined based on a synthesis of values of the plurality of intermediate software-targeted testing-inquiry results.
